(19) United States
(12) Patent Application Publication
(10) Pub. No.: US 2015/0123424 A1
(43) Pub. Date: May 7, 2015

(54) SIDE DOOR EXTENSION SUPPORT ASSEMBLY

(71) Applicant: Honda Motor Co., Ltd., Tokyo (JP)

(72) Inventors: Erik R. Anderson, Marysville, OH (US); Steven R. Thiele, Marysville, OH (US)

(73) Assignee: Honda Motor Co., Ltd., Tokyo (JP)

(21) Appl. No.: 14/071,694

(22) Filed: Nov. 5, 2013

(51) Int. Cl. B60J 5/06

(52) U.S. Cl. CPC B60J 5/06
USPC 296/155

(57) ABSTRACT

A side door extension support assembly for a vehicle includes a side door moveably mounted on a vehicle body of the vehicle for longitudinal movement between a closed position and an open position and an extension member mounted to the side door and moveable between a retracted position and an extended position for supporting the side door. Movement of the extension member corresponds to longitudinal movement of the side door such that the extension member moves to the extended position when the side door is moved from the closed position to the open position, and the extension member moves to the retracted position when the side door is moved from the open position to the closed position.

### BACKGROUND

Side doors on vehicles (e.g., minivans) continue to evolve. One advancement is the use of four-bar linkages to control movement of the side door when the side door is moved longitudinally between closed and open positions. Such opening mechanisms potentially result in the side door having a lower stiffness as compared to conventional three-rail side doors. Such lower stiffness is particularly noticeable when the side door is pushed or pulled at the rear-most edge thereof. This potentially creates a negative impact in perceived quality by the customer when pushing or pulling on the side door, which has the potential to give the impression that the door is “cheap” or structurally flimsy, whether this perception is actual or not. Additionally, some market case studies have shown that rigidity of side vehicle doors is important to customers, in particular as concerns leaning against a fully open door and/or waxing the side door when in the open state.

### SUMMARY

According to one aspect, a side door extension support assembly for a vehicle includes a side door moveably mounted on a vehicle body of the vehicle for longitudinal movement between a closed position and an open position and an extension member mounted to the side door and moveable between a retracted position and an extended position for supporting the side door. Movement of the extension member corresponds to longitudinal movement of the side door such that the extension member moves to the extended position when the side door is moved from the closed position to the open position, and the extension member moves to the retracted position when the side door is moved from the open position to the closed position.

According to another aspect, a side door assembly on a vehicle includes a side door mounted on a lateral side of the vehicle for closing a door opening providing ingress and egress for the vehicle. The side door is moveable from a closed position wherein the side door closes the door opening to an open position wherein the side door is removed from the door opening. The side door assembly further includes an extension member mounted to the side door for supporting the side door when the side door is in the open position. The extension member is moved from a retracted position to an extended position when the side door is moved to the open position.

According to a further aspect, a side door extension support method is provided for a vehicle. More particularly, in accordance with the method, a side door mounted on a vehicle for longitudinal movement between a closed position and an open position is provided. An extension member mounted on the side door for movement between a retracted position and an extended position for supporting the side door is also provided. The side door is moved between the closed position and the open position. The extension member is moved between the retracted position and the extended position based on movement of the side door. The extension member is moved to the extended position when the side door is moved from the closed position to the open position and the extension member is moved to the retracted position when the side door is moved from the open position to the closed position.

### BRIEF DESCRIPTION OF THE DRAWINGS

FIG. 1 is a side elevation view of a vehicle having a side door moveably mounted thereon for longitudinal movement, the side door shown in a closed position.

FIG. 2 is a side elevation view of the vehicle similar to FIG. 1 but showing the side door in an open position.

FIG. 3 is a cross-sectional view taken along the line 3-3 of FIG. 1 showing an extension member that is mounted to the side door in a retracted position.

FIG. 4 is a cross-sectional view taken along the line 4-4 of FIG. 2 showing the extension member in an extended position to support the side door relative to a vehicle body of the vehicle.

FIG. 5 is an enlarged perspective view, partially in cross-section, of the extension member mounted to the side door showing the extension member in the extended position.

FIG. 6 is another enlarged perspective view showing the extension member mounted to the vehicle similar to FIG. 5 but shown from an opposite side of the extension member.

FIG. 7 is a partial rear elevation view, partially in cross-section, showing the extension member in the extended position and positioned adjacent the vehicle body.

FIG. 8 is a rear elevation view similar to FIG. 7 but without the vehicle body and showing the extension member in the retracted position.

FIG. 9 is a cross-section view taken along the line 9-9 of FIG. 7 showing a shoulder bolt pivotally connecting the extension member to the side door.

FIG. 10 is a perspective view, partially in cross-section of an extension member mounted to a side door according to an alternate exemplary embodiment.

FIG. 11 is a cross-sectional view taken along the line 11-11 of FIG. 10 showing a swaged-pin assembly pivotally connecting the extension member to the side door.

### DETAILED DESCRIPTION

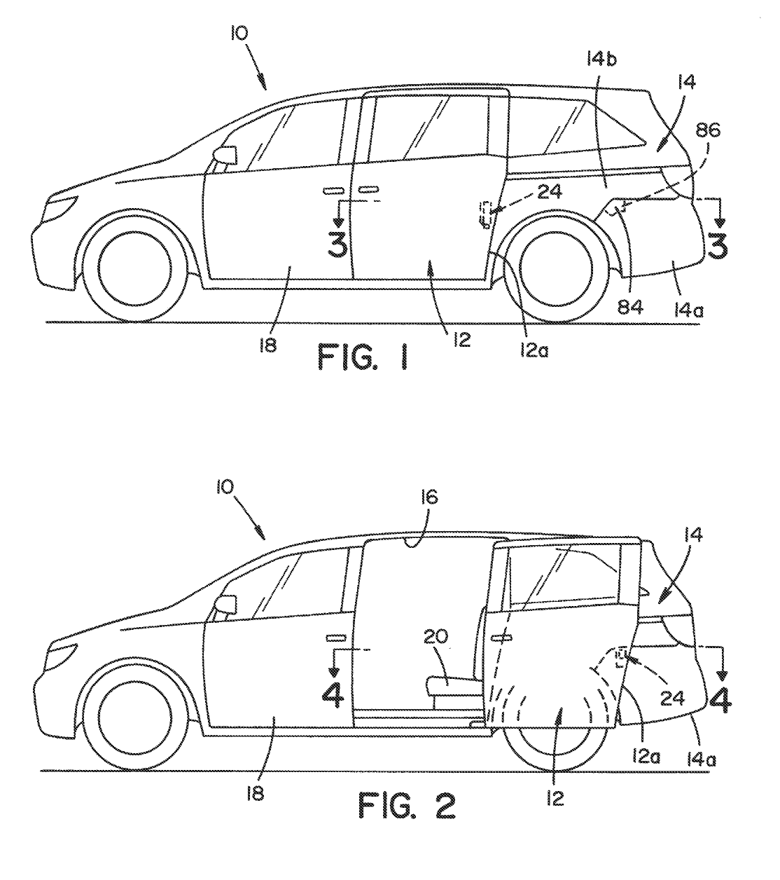

Referring now to the drawings wherein the showings are for purposes of illustrating one or more exemplary embodiments and not for purposes of limited the same, FIGS. 1 and 2 illustrate a vehicle 10 having a side door 12 moveably mounted on a vehicle body 14 of the vehicle 10 and longitudinally moveable between a closed position (shown in FIG. 1) and an open position (shown in FIG. 2). As used herein, the term “longitudinally moveable” corresponds to a longitudinal dimension for the vehicle 10 and/or to a direction of travel for the vehicle 10. As shown in the illustrated embodiment, the side door 12 may be laterally moveable in addition to being longitudinally moveable as will be known and understood by those skilled in the art. For example, the side door 12 may move laterally outward to enable the side door 12 to move from the closed position longitudinally rearward relative to the vehicle 10 to the open position. As shown, the illustrated side door 12 is mounted on a lateral side (i.e., the side shown in FIGS. 1 and 2) of the vehicle 10 for closing a door opening 16 providing ingress and egress for the vehicle 10 and thus the side door 12 moves longitudinally relative to the door opening 16.

Also as shown, the door opening 16 and the side door 12 provided in association with the door opening 16 are arranged rearward to a front door 18 and specifically provide ingress and egress for the vehicle 10 in association with a rear row of seats 20 (FIG. 2) disposed within the vehicle 10. In particular, the side door 12 is longitudinally moveable from the closed position shown in FIG. 1 wherein the side door 12 closes the door opening 16 to the open position shown in FIG. 2 wherein the side door 12 is removed or displaced from the door opening 16 and moved rearward relative thereto. As shown, the side door 12 can be displaced rearwardly relative to a forward direction of travel for the vehicle 10 when the side door 12 is opened and displaced forwardly relative to a forward direction of travel for the vehicle 10 when the side door 12 is closed.

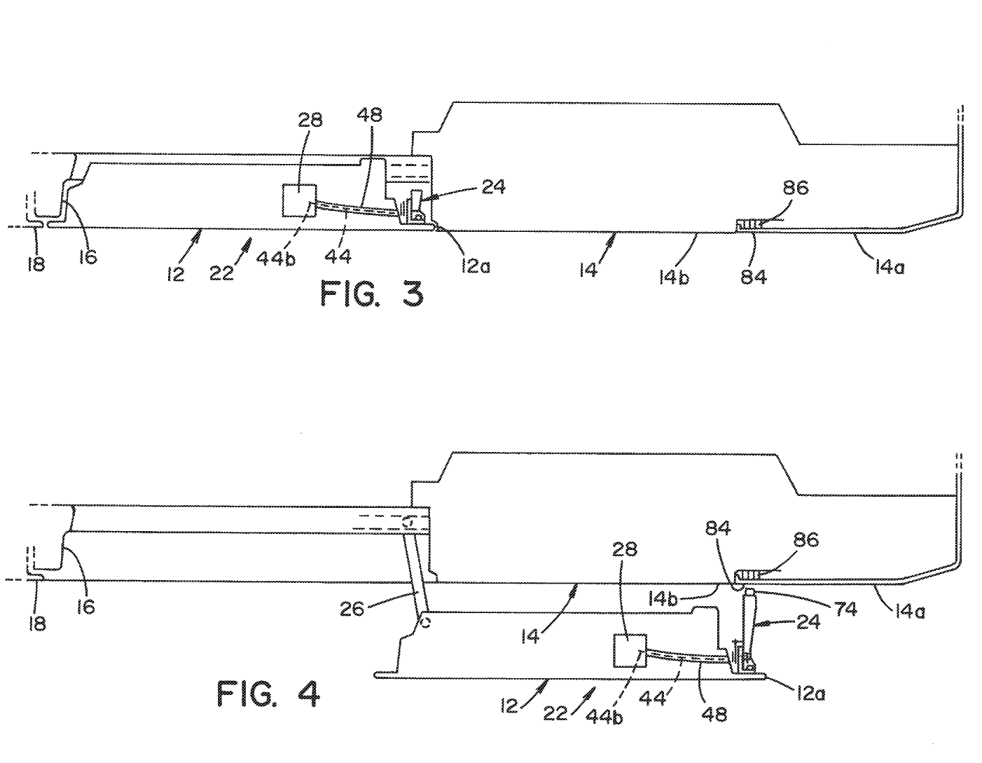

With additional reference to FIGS. 3 and 4, the side door 12 can be comprised as part of a side door extension support assembly 22, which is also referred to herein as a side door assembly 22 on the vehicle 10. In one embodiment, the side door extension support assembly 22 includes a four-bar linkage (only link 26 shown) for controlling movement of the side door 12 between the open and closed positions as will be known and understood by those skilled in the art, though this is not required and other mechanisms can be used for controlling movement of the side door 12. In addition to including the side door 12, the side door extension support assembly 22 can further include an extension member 24 mounted to the side door 12 and moveable between a retracted position (shown in FIG. 3) and in extended position (shown in FIG. 4) for supporting the side door 12, particularly when the side door 12 is in the open position. In particular, as shown in the illustrated embodiment, the extension member 24 can be disposed adjacent a rear longitudinal end or edge 12a of the side door 12.

In the illustrated embodiment, the extension member 24 is shown mounted on the side door 12 adjacent a rear edge 12a of the side door 12 for supporting the side door 12 when the side door 12 is in the open position. More particularly, the extension member 24 is laterally moveable from the retracted position to the extended position when the side door is longitudinally moved to the open position. Likewise, the extension member 24 is laterally moveable from the extended position to the retracted position when the side door is longitudinally moved to the closed position. In one embodiment, as will be described in more detail below, lateral movement of the extension member 24 is linked to longitudinal movement of the side door 12 (or movement of the side door 12 between the open and closed positions) through a door actuator 28. The extension member 24 can be particularly arranged so as to be aligned to be locally normal (i.e., orthogonal) to the vehicle body 14 or at least to a portion of the vehicle body 14 against which the extension member 24 may contact (e.g., contact location 84).

Accordingly, and as will be described in more detail below, movement of the extension member 24 can correspond to movement of the side door 12 such that the extension member 24 moves to the extended position when the side door 12 is moved from the closed position to the open position, and the extension member 24 moves to the retracted position when the side door 12 is moved from the open position to the closed position. Advantageously, the foregoing provides support to the side door 12 when necessary but retracts back into or to the side door 12 during closing of the side door 12. The door actuator 28 can mechanically or otherwise link movement of the side door 12 to the extension member (e.g., via cable 44) so that the position of the side door 12 and/or movement of the side door 12 toward one of the open or closed positions is communicated and transferred into lateral movement of the extension member 24. In another embodiment, the door actuator 28 can be electronically controlled to link movement of the side door 12 to the extension member 24.

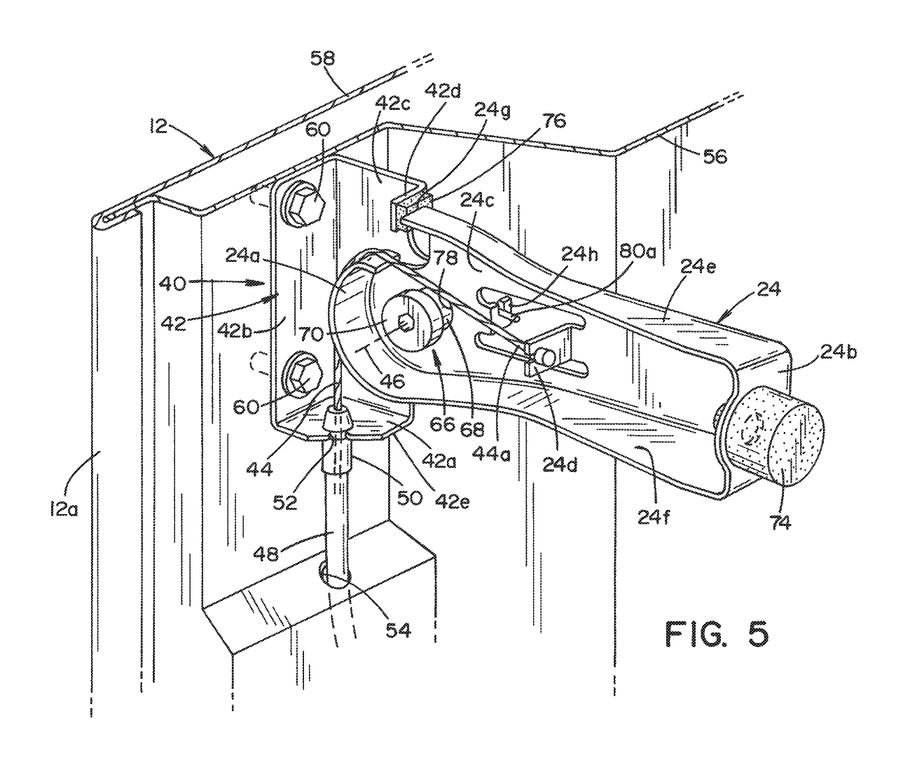

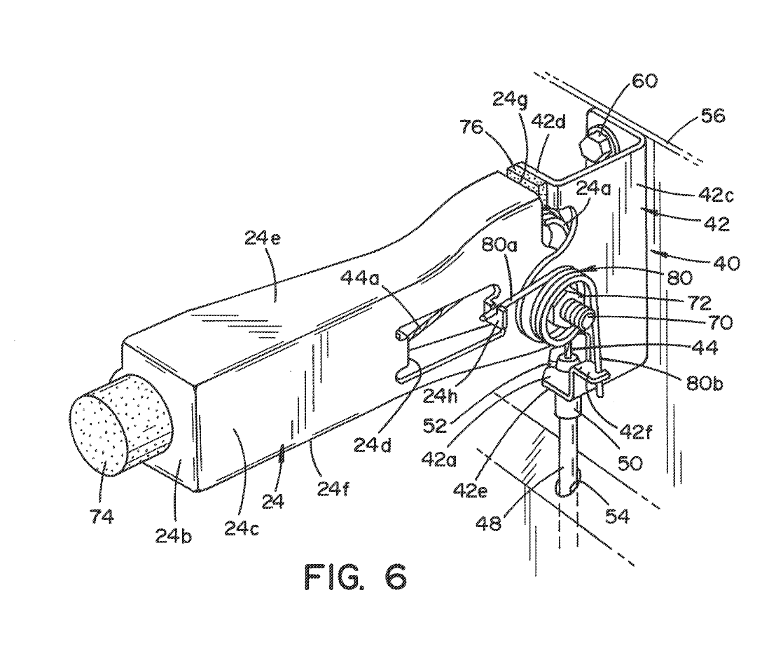

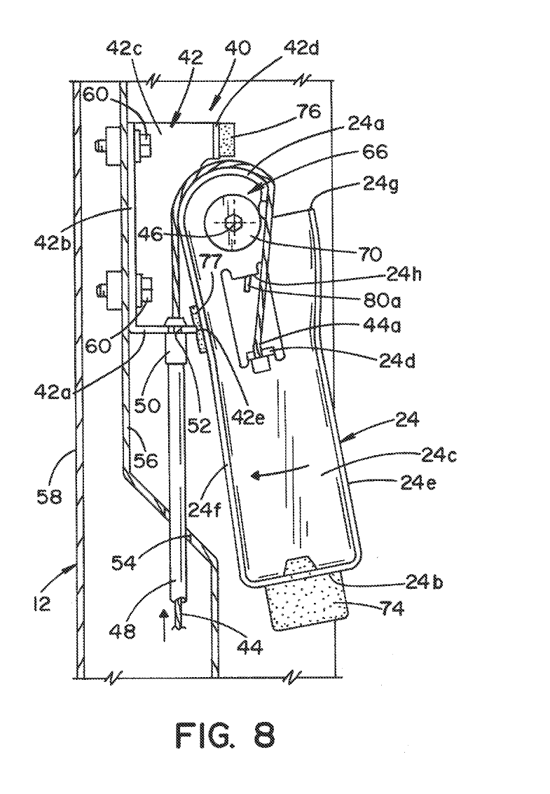

With additional reference to FIGS. 5-9, a movement control mechanism 40 is illustrated and is included as an additional part or element of the side door extension support assembly 22. As will be described in more detail herein, the movement control mechanism 40 controls movement of the extension member 24, including moving the extension member 24 between the extended position shown in FIGS. 5, 6 and 7 and the retracted position shown in FIG. 8. In the illustrated embodiment, the movement control mechanism 40 includes a base part 42 that is mounted to the side door 12 and provides a common structural mounting for other components of the movement control mechanism 40. This advantageously provides a modular construction whereby components of the movement control mechanism 40 can all be mounted to the base part 42 (e.g., as a sub-assembly) and the base part 42 can be secured to the side door 12 when appropriate or desired during the manufacturing process.

The movement control mechanism 40 of the illustrated embodiment includes a cable 44 having one end 44a attached to the extension member 24 with the extension member 24 pivotally attached to the side door 12 and arranged such that pulling of the cable 44 moves the extension member 24 from the retracted position to the extended position. In particular, the end 44a of the cable 44 is connected to the extension member 24 at a location spaced apart from a pivot axis or location 46 at which the extension member 24 is pivotally connected to the side door 12 so that pulling of the cable 44 causes the extension member 24 to pivot about the pivot axis or location 46 and moved to the extended position. The cable 44 can have a second end 44b that is operatively arranged so that movement of the side door 12 from the closed position to the open position pulls the cable 44. In one embodiment, the second end 44b is connected to the door actuator 28 that is mechanically triggered when the side door 12 moves from the closed position to the open position to thereby pull the cable 44 and move the extension member 24 from the retracted position to the extended position. Accordingly, the extension member 24 is moved from the retracted position to the extended position when the side door 12 is moved from the closed position to the open position.

A sheath 48 can be provided in association with the cable 44 and can have a sheath end fitting 50 received in a mounting aperture 52 defined on a bottom side or wall 42a of the base part 42. The sheath 48 can be disposed so as to pass through a door aperture 54 and routed between panel members 56, 58 together forming the side door 12 so that the cable 44 can be routed inside the side door 12 to the door actuator 28. The base part 42 can be secured to the side door 12, such as to the panel 56 of the side door 12, via any suitable fastener, such as the illustrated bolts 60. In particular, bolts 60 can secure mounting wall 42b of the base part 42 to the panel 56 of the side door 12. In the illustrated embodiment, the base part 42 is shown as a separate part (e.g., a small stamping part) that is secured to the side door 12; however, it is to be appreciated and understood by those skilled in the art that the base part 42 could alternatively integrated into existing components (e.g., formed as part of the side door 12), if desired.

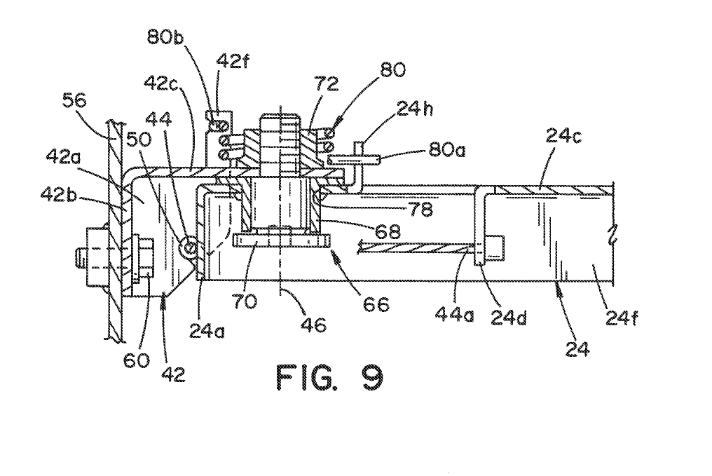

The extension member 24 includes a proximal end 24a and a distal end 24b. In the illustrated embodiment, the proximal end 24a is formed by a curved flange or surface that is concentric with the axis 46 about which the extension member 24 is pivotally mounted to the side door 12. The cable 44 is routed about the curved proximal end 24a such that pulling of the cable 44 pivotally moves the extension member 24. In particular, a side wall portion 24c of the extension member 24 extends between the proximal end 24 and the distal end 24b. The side wall portion 24c is pivotally mounted to the side door 12 adjacent to the proximal end 24a and can be particularly arranged so that the cable 44 extends from the proximal end 24a in line with a tangent formed by the curve of the proximal end 24a. In particular, and with specific reference to FIG. 9, a shoulder bolt assembly 66 is used to pivotally mount the extension member 24 to the side door 12, and more particularly to mount the side wall portion 24c of extension member 24 to the mounting wall 42c. The shoulder bolt assembly 66 can include an annular mounting member 68 received through an aperture 78 defined in the side wall portion 24c of the extension member 24. The shoulder bolt assembly 66 can also include a bolt member 70 and a nut member 72 for securing the annular mounting member 68 to the mounting wall 42c of the base part 42.

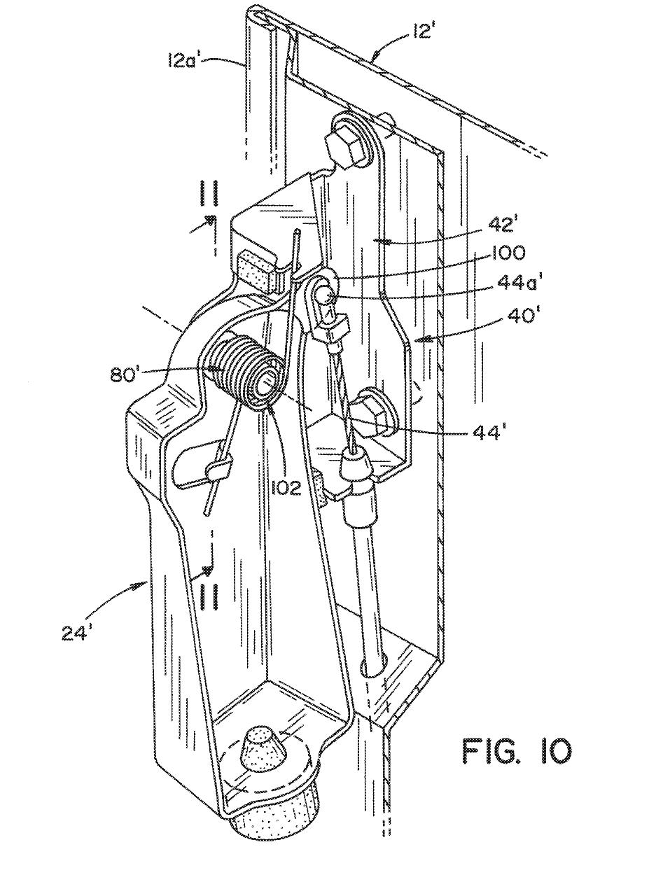

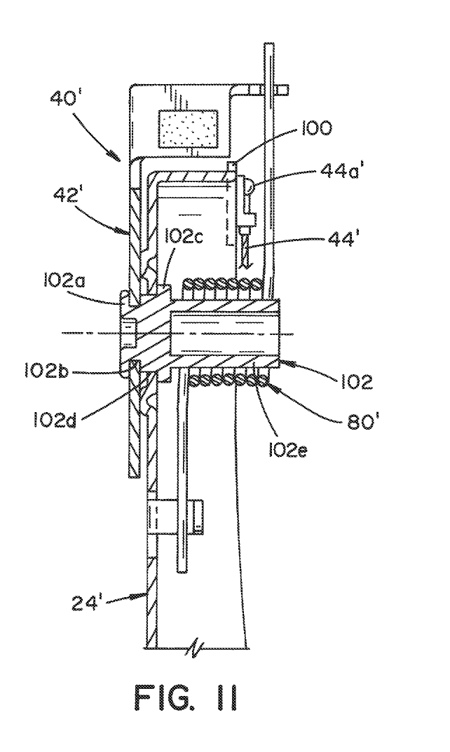

Advantageously, the illustrated shoulder bolt assembly 66 can provide higher stiffness to the pivotal connection between the extension member 24 and the base part 42, particularly to inhibit bending resulting from loads applied in a longitudinal direction relative to the vehicle 10 at the distal end 24b of the extension member 24. Alternatively, the pivotal connection between the extension member 24 and the base part 42 could be a swaged pin design (e.g., using the swaged pin 102 of FIGS. 10 and 11) or any other known pivotal connection. A mounting flange 24d can protrude orthogonally from the side wall portion 24c for securing the first end 44a of the cable 44 to the extension member 24. As shown, the end 44a of the cable 44 is mounted to the extension member 24 at the location of the mounting flange 24d, which is a location spaced apart from and disposed between the pivot axis or location 46 at which the extension member 24 is pivotally mounted to the side door 12 and the distal end 24b of the extension member 24.

As shown, a bumper 74 can be secured to the distal end 24b of the extension member 24. The bumper 74 can be formed with a material that is less rigid than the extension member 24. For example, the extension member 24 can be formed of aluminum or steel and the bumper 74 can be formed of a resilient material such as hard rubber or the like. The bumper 74 provides a less rigid contact structure for instances where the extension member 24 contacts the vehicle body 14 of the vehicle 10 (e.g., when an external lateral force is applied against the side door 12 while in the open position) to thereby avoid hard and/or noisy contact with the vehicle body 14.

As shown in the illustrated embodiment, the extension member 24 can additionally include a first side flange 24e and a second side flange 24f. When in the extended position shown in FIG. 5, the first side flange 24e is an upper flange and the second side flange 24f is a lower flange. A rear edge 24g of the first side flange 24e forms a stop surface that limits movement of the extension member 24 when moving from the retracted position to the extended position. That is, the extension member 24 cannot move upward (counter-clockwise in FIG. 5) due to engagement of the rear edge 24g with the base part 42. As shown, the base part 42 can include a stop flange 42d with a bumper 76 secured thereto for engaging the rear edge 24g. Like the bumper 74, the bumper 76 can be formed of a less rigid material than the base part 42. In one example, the base part 42 is formed with aluminum or steel and the bumper 76 is formed of a resilient material, such as hard rubber. As best shown in FIG. 8, the second side flange 24f also forms a stop for limiting movement of the extension member 24 when moving from the extended position to the retracted position due to the second side flange 24f engaging edge 42e of the bottom wall 42a on the base part 42. As shown, a bumper 77, which can be formed like the bumper 76, can be secured to the second side flange 24f at a location appropriate for the bumper 77 to align with and contact the engaging edge 42e.

The extension member 24 can be particularly arranged such that gravity urges the extension member 24 toward the retracted position shown in FIG. 8 and pulling of the cable 44 moves the extension member 24 from the retracted position to the extended position shown in FIGS. 5, 6 and 7 against the urging by gravity. Though not required, a torsion spring 80 can also be employed for urging the extension member 24 toward the retracted position shown in FIG. 8 and thus pulling of the cable 44 in this embodiment moves the extension member 24 against the urging of the torsion spring 80. In the illustrated embodiment, the torsion spring 80 includes a first arm 80a that engages or is received within an aperture defined on a spring flange 24h protruding orthogonally from the side wall portion 24c of the extension member 24 and an arm 80b engages or is received within an aperture defined in a spring flange 42f protruding from the mounting wall 42c of the base part 42. The torsion spring can be used to urge the extension member 24 toward the retracted position. This can be in addition to gravity.

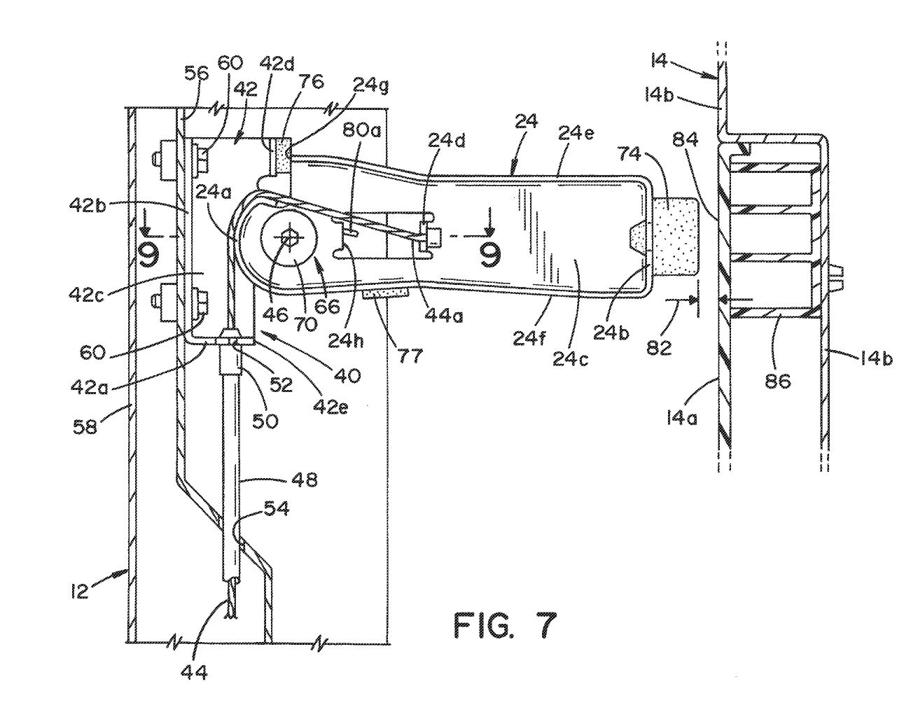

As best shown in FIGS. 4 and 7, a small clearance gap 82 is defined between the distal end of the extension member 24 and the vehicle body 14, and particularly between the bumper 74 and the vehicle body 14. In one embodiment, the small clearance gap 82 is between six (6) and ten (10) millimeters. In an exemplary embodiment, small clearance gap is about eight (8) millimeters. By this arrangement, the extension member 24 does not normally contact the vehicle body 14 until an external force is applied laterally inwardly against the side door 12. In this instance, the extension member 24 contacts the vehicle body 14 and limits further inward lateral movement of the side door 12 relative to the vehicle body 14. In an alternative embodiment not shown herein, interference can be purposely created between the extension member 24 and the vehicle body 14. That is, the extension member 24 can initially contact the vehicle body 14 and thus the small clearance gap can be eliminated. In this alternate embodiment, there is no minimal clearance to pass before the stabilization benefit of the extension member 24 is achieved. Additionally, and due to the slight pre-loading of the side door 12, the rear edge 12a of the side door 12 can resist both inboard and outboard displacement (i.e., both push and pull loads applied externally by a customer).

Returning to FIG. 1, a contact location on the vehicle body 14 is noted by reference numeral 84. This contact location 84 can be provided on rear bumper fascia member 14a, which is one member or panel of the vehicle body 14. In particular, the contact location 84 is illustrated adjacent a perimeter of the rear bumper fascia member 14a in the illustrated embodiment. This can coincide with a spacer reinforcement 86 (see FIG. 7) provided at this location, which can be utilized to provide load transfer back to the vehicle body 14 (e.g., panel 14b in the illustrated embodiment). Optionally, further underlying reinforcements can be provided and/or the contact location 84 can alternately be moved to some other location on the vehicle body 14.

In operation, as the side door 12 opens, moving rearward, the extension member 24 extends laterally outward from the side door 12, reaching the fully extended position. In one embodiment, the extension member 24 reaches the extended position prior to the side door 12 reaching the open position when the side door 12 is moved from the closed position to the open position. In particular, movement of the side door 12 from the closed position to the open position can be communicated via the door actuator 28 to the extension member 24 via the cable 44. In particular, the door actuator 28 can pull the cable 44 when the side door 12 is moved from the closed position to the open position thereby moving the extension member 24 from the retracted position to the extended position. The engagement between the rear edge 24g of the first side flange 24e against the bumper 76 on the stop flange 42d limits movement of the extension member 24 beyond the extended position shown in FIG. 5. In this position, the extension member 24 is ideally situated so that, should an external lateral force be applied against the side door 12, the extension member 24 can contact the vehicle body 14 and provide rigid support for the side door 12. When the side door 12 is returned from the open position to the closed position, the door actuator 28 no longer pulls on the cable 44 and so gravity and/or the torsion spring 80 can return the extension member 24 to the retracted position shown in FIG. 8.

With reference now to FIGS. 10 and 11, an extension member 24′ and a movement control mechanism 40′ therefor are shown mounted a the side door 12′ according to an alternate exemplary embodiment. Except as indicated below, the extension member 24′ and the movement control mechanism 40′ can be the same as the extension member 24 and the movement control mechanism 40 described hereinabove with reference to FIGS. 5-9 and thus like elements in the embodiment of FIGS. 10 and 11 use like reference numerals with a prime (′) suffix added. More particularly, the movement control mechanism 40′ includes a base part 42′ mounted to the side door 12′ and the extension member 24′ pivotally mounted to the base part 42′ A cable 44′ has one end 44a′ attached to the extension member 24′ and arranged such that pulling of the cable 44′ moves the extension member 24′ from a retracted position to an extended position. Specific to the embodiment of FIGS. 10 and 11, the end 44a′ of the cable 44′ is attached to an arm portion 100. The other end (not shown) of the cable 44′ can be arranged as described above in reference to the cable 44.

As shown in FIG. 11, the extension member 24′ is pivotally mounted to the side door 12′, and particularly to the base part 42′, by a swaged pin 102. In particular, the swaged pin 102 includes a head portion 102a defining a mounting recess 102b for connecting to the base part 42′, flange portion 102c for defining a pivot recess 102d for receipt of the extension member 24′ and a shaft portion 102e extending therefrom. A torsion spring 80′ is annually mounted to the shaft portion 102e and can function like the spring 80. It is to be appreciated that the swaged pin 102 could be used in the embodiment of FIGS. 5-9 for connecting the extension member 24 to the base part 42 and/or the shoulder bolt assembly 66 could be used for connecting the extension member 24′ to the base part 42′.

Also particular to the embodiment shown in FIGS. 10 and 11, the extension member 24′ is open in a direction away from a rear edge 12a′ of the side door 12. This is opposite the orientation of the extension member 24 of FIGS. 5-9. By this arrangement, the shaft portion 102e and the spring 80′ received thereon are at least partially housed by the extension member 24′ and at least partially concealed by the extension member 24′ relative to the rear edge 12a′. This has the advantage of reducing exposure of the spring 80′ and the pivot connection between the extension member 24′ and the base part 42′, and additionally improves aesthetics related to the extension member 24′ and the side door 12′ as viewing of the working components (e.g., spring 80′ and connection with the cable 44′) is hidden when viewed from the rear edge 12a′ of the side door 12′. It is to be appreciated that this arrangement for the extension member 24′ (i.e., facing away from the rear edge 12a′) could be used for the extension member 24 of FIGS. 5-9 and/or the arrangement for the extension member 24 of FIGS. 5-9 could be used for the extension member 24′.

A side door extension support method for a vehicle will now be described. In particular, the method will be described in association with the side door extension support assembly 22 described hereinabove, though this is not required and the method could be used with other assemblies. In the method, the side door 12 mounted on the vehicle 10 for longitudinal movement between the closed position and the open position is provided. The extension member 24 mounted to the side door 12 for movement between the retracted position and the extended position for supporting the side door 12 is also provided. In operation, the side door 12 is moved between the closed position and the open position. The extension member 24 is likewise moved between the retracted position and the extended position, but based on the movement of the side door 12. In particular, the extension member 24 is moved to the extended position when the side door 12 is moved from the closed position to the open position and the extension member 24 is moved from the extended position to the retracted position when the side door is moved from the open position to the closed position.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A side door extension support assembly for a vehicle, comprising:
a side door moveably mounted on a vehicle body of the vehicle for longitudinal movement between a closed position and an open position; and
an extension member mounted to the side door and movable between a retracted position and an extended position for supporting the side door, movement of the extension member corresponding to longitudinal movement of the side door such that the extension member moves to the extended position when the side door is moved from the closed position to the open position, and the extension member moves to the retracted position when the side door is moved from the open position to the closed position.

2. The side door extension support assembly of claim 1 wherein the extension member reaches the extended position prior to the side door reaching the open position when the side door is moved from the closed position to the open position.

3. The side door extension support assembly of claim 1 wherein a small clearance gap is defined between a distal end of the extension member and the side door when the extension member is in the extended position.

4. The side door extension support assembly of claim 3 wherein the small clearance gap is between 6 and 10 mm.

5. The side door extension support assembly of claim 1 wherein the extension member contacts the vehicle body when in the extended position to pre-load the side door.

6. The side door extension support assembly of claim 1 further including a cable having one end attached to the extension member with the extension member pivotally attached to the side door and arranged such that pulling of the cable moves the extension member from the retracted position to the extended position.

7. The side door extension support assembly of claim 6 wherein the extension member is arranged such that gravity urges the extension member toward the retracted position and pulling of the cable moves the extension member against the urging by gravity.

8. The side door extension support assembly of claim 6 further including a torsion spring urging the extension member toward the retracted position and pulling of the cable moves the extension member against the urging of the torsion spring.

9. The side door extension support assembly of claim 1 wherein the extension member is arranged to contact the vehicle body when a load is applied to side door in the open position at or near a perimeter of a rear bumper fascia of the vehicle body.

10. The side door extension support assembly of claim 1 wherein the extension member includes a proximal end and a distal end having a bumper secured thereto, the bumper formed of a material that is less rigid than the extension member for contact with the vehicle body.

11. The side door extension support assembly of claim 1 wherein the extension member includes proximal end having a curved surface that is concentric with an axis about which the extension member is pivotally mounted to the side door, an actuating cable has one end attached to the extension member and is routed around the curved surface such that pulling of the cable pivotally moves the extension member.

12. The side door extension support assembly of claim 11 wherein the extension member has a distal end, and wherein the one end of the cable is mounted to the extension member at a location spaced apart from and disposed between a pivot location at which the extension member is pivotally mounted to the side door and the distal end of the extension member.

13. The side door extension support assembly of claim 1 further including:
a cable having a first end connected to the extension member so that pulling of the cable causes the extension member to pivot about the pivot location and move to the extended position and a second end that is operatively arranged so that movement of the side door from the closed position to the open position pulls the cable.

14. The side door extension support assembly of claim 1 wherein the extension member is open in a direction away from a rear edge of the side door.

15. A side door assembly on a vehicle, comprising:
a side door mounted on a lateral side of the vehicle for closing a door opening providing ingress and egress for the vehicle, the side door movable from a closed position wherein the side door closes the door opening to an open position wherein the side door is removed from the door opening; and
an extension member mounted to the side door for supporting the side door when the side door is in the open position, the extension member moved from a retracted position to an extended position when the side door is moved to the open position.

16. The side door assembly of claim 15 wherein the extension member is moved from the extended position to the retracted position when the side door is moved to the closed position.

17. The side door assembly of claim 16 wherein at least one of a torsion spring or gravity moves the extension member from the extended position to the retracted position when the side door is moved to the closed position from the open position.

18. The side door assembly of claim 15 wherein the extension member includes a distal end that is spaced apart from the lateral side of the vehicle when the extension member is in the extended position and no external lateral forces are applied to the side door.

19. The side door assembly of claim 15 wherein the extension member is disposed adjacent a rear longitudinal end of the side door.

20. A side door extension support method for a vehicle, comprising:
providing a side door mounted on a vehicle for longitudinal movement between a closed position and an open position;
providing an extension member mounted on the side door for movement between a retracted position and an extended position for supporting the side door;
moving the side door between the closed position and the open position; and
moving the extension member between the retracted position and the extended position based on movement of the side door, the extension member moved to the extended position when the side door is moved from the closed position to the open position and the extension member moved to the retracted position when the side door is moved from the open position to the closed position.
